(19) United States
(12) Patent Application Publication
(10) Pub. No.: US 2026/0254593 A1
(43) Pub. Date: Aug. 27, 2026

(54) DYNAMIC RESOURCE USAGE

(71) Applicant: Nokia Technologies Oy, Espoo (FI)

(72) Inventors: Matha DEGHEL, Paris (FR); Arto LEHTI, Antony (FR)

(21) Appl. No.: 18/879,309

(22) PCT Filed: Jun. 29, 2022
(86) PCT No.: PCT/EP2022/067822

§ 371 Date: Dec. 27, 2024

(51) Int. Cl. H04L 5/00; H04W 72/21

(52) U.S. Cl. CPC H04L 5/0064; H04L 5/0007; H04L 5/0053; H04L 5/0091; H04W 72/21

(57) ABSTRACT

According to an example aspect of the present invention, there is provided an apparatus, for example a user equipment, configured to store, for use on an uplink control channel, a first resource or configuration using a first waveform, and a second resource or configuration using a second waveform, the second waveform having a lower peak-to-average power ratio than the first waveform, and store a long and a short format for the uplink control channel, and select one of the first and the second resource or configuration and/or one of the long and short format for use on at least a part of the uplink control channel based on signalling received in the apparatus from a base station device.

### FIELD

The present disclosure relates to dynamic resource usage in wireless communication systems.

### BACKGROUND

In some wireless communication systems, more than one signal waveform is usable in wireless communication between a user equipment, UE, and an access node, such as, for example, a base station. A waveform of a signal corresponds to a shape of a graph of the signal as a function of time. Examples of waveforms include sinusoid, square and triangle waveforms, although in communication systems the waveforms are more complex in shape owing to modulation used. Modulation used in wireless communication systems may be of a high order, and in general a modulation scheme is correlated with a characteristic waveform of the modulation scheme.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core, at least one memory including computer program code, the at least one memory and the computer program code being configured to, with the at least one processing core, cause the apparatus at least to store, for use on an uplink control channel, a first resource or configuration using a first waveform, and a second resource or configuration using a second waveform, the second waveform having a lower peak-to-average power ratio than the first waveform, and store a long and a short format for the uplink control channel, select one of the first and the second resource or configuration and/or one of the long and short format for use on at least a part of the uplink control channel based on signalling received in the apparatus from a base station device, wherein the selecting comprises either: selecting the second resource or configuration and/or the long format for the uplink control channel as a response to the signalling indicating use of the second waveform for an uplink shared channel, or selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

According to a second aspect of the present disclosure, there is provided an apparatus comprising at least one processing core, at least one memory including computer program code, the at least one memory and the computer program code being configured to, with the at least one processing core, cause the apparatus at least to provide, to a user equipment, for use on an uplink control channel, a first resource or configuration which uses a first waveform, and a second resource or configuration which uses a second waveform, the second waveform having a lower peak-to-average power ratio than the first waveform, and provide signalling to the user equipment, the signalling defining use of the first or the second waveform for use in a physical uplink shared channel or in communication of an information element from the user equipment.

According to a third aspect of the present disclosure, there is provided a method comprising storing, in an apparatus, for use on an uplink control channel, a first resource or configuration using a first waveform, and a second resource or configuration using a second waveform, the second waveform having a lower peak-to-average power ratio than the first waveform, and storing a long and a short format for the uplink control channel, selecting one of the first and the second resource or configuration and/or one of the long and short format for use on at least a part of the uplink control channel based on signalling received in the apparatus from a base station device, wherein the selecting comprises either selecting the second resource or configuration and/or the long format for the uplink control channel as a response to the signalling indicating use of the second waveform for an uplink shared channel, or selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

According to a fourth aspect of the present disclosure, there is provided an apparatus comprising means for storing, in an apparatus, for use on an uplink control channel, a first resource or configuration using a first waveform, and a second resource or configuration using a second waveform, the second waveform having a lower peak-to-average power ratio than the first waveform, and storing a long and a short format for the uplink control channel, selecting one of the first and the second resource or configuration and/or one of the long and short format for use on at least a part of the uplink control channel based on signalling received in the apparatus from a base station device, wherein the selecting comprises either selecting the second resource or configuration and/or the long format for the uplink control channel as a response to the signalling indicating use of the second waveform for an uplink shared channel, or selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

According to a fifth aspect of the present disclosure, there is provided a non-transitory computer readable medium having stored thereon a set of computer readable instructions that, when executed by at least one processor, cause an apparatus to at least store, for use on an uplink control channel, a first resource or configuration using a first waveform, and a second resource or configuration using a second waveform, the second waveform having a lower peak-to-average power ratio than the first waveform, and store a long and a short format for the uplink control channel, select one of the first and the second resource or configuration and/or one of the long and short format for use on at least a part of the uplink control channel based on signalling received in the apparatus from a base station device, wherein the selecting comprises either selecting the second resource or configuration and/or the long format for the uplink control channel as a response to the signalling indicating use of the second waveform for an uplink shared channel, or selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

According to a sixth aspect of the present disclosure, there is provided a non-transitory computer readable medium having stored thereon a set of computer readable instructions that, when executed by at least one processor, cause an apparatus to at least provide, to a user equipment, for use on an uplink control channel, a first resource or configuration using a first waveform, and a second resource or configuration using a second waveform, the second waveform having a lower peak-to-average power ratio than the first waveform, and provide signalling to the user equipment, the signalling defining use of the first or the second waveform for use in a physical uplink shared channel or in communication of an information element from the user equipment.

According to a seventh aspect of the present disclosure, there is provided a computer program configured to cause an apparatus to perform at least the following, when run by the apparatus: store, for use on an uplink control channel, a first resource or configuration using a first waveform, and a second resource or configuration using a second waveform, the second waveform having a lower peak-to-average power ratio than the first waveform, and store a long and a short format for the uplink control channel, select one of the first and the second resource or configuration and/or one of the long and short format for use on at least a part of the uplink control channel based on signalling received in the apparatus from a base station device, wherein the selecting comprises either selecting the second resource or configuration and/or the long format for the uplink control channel as a response to the signalling indicating use of the second waveform for an uplink shared channel, or selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

### BRIEF DESCRIPTION OF THE DRAWINGS

FIG. 1 illustrates an example system in accordance with at least some embodiments of the present invention;

FIG. 2 illustrates an example process in accordance with at least some embodiments of the present invention;

FIG. 3 illustrates an example apparatus capable of supporting at least some embodiments of the present invention;

FIG. 4 illustrates signalling in accordance with at least some embodiments of the present invention, and

FIG. 5 is a flow graph of a method in accordance with at least some embodiments of the present invention.

### EMBODIMENTS

Methods are herein disclosed which enable a quick and intelligently adaptive manner of switching between waveforms in wireless communication between a user equipment, UE, and a base station device, such as a base station, a distributed unit or a relay node. In detail, a UE is enabled to select a waveform to use on an uplink, UL, control channel, such as, for example, an uplink physical control channel. Waveforms in general have different characteristics, such as peak-to-average power ratio, PAPR. A waveform with a lower PAPR is better suited to serving a UE near to a cell edge, or in another coverage limited scenario, than a waveform with a higher PAPR. In detail, using a waveform with lower PAPR in coverage-limited scenarios provides a technical benefit in terms of reduced interference in the system. In case switching to such a waveform may be accomplished without explicit signalling, the reduction of interference is even greater, as the explicit signalling would in itself cause interference in the system.

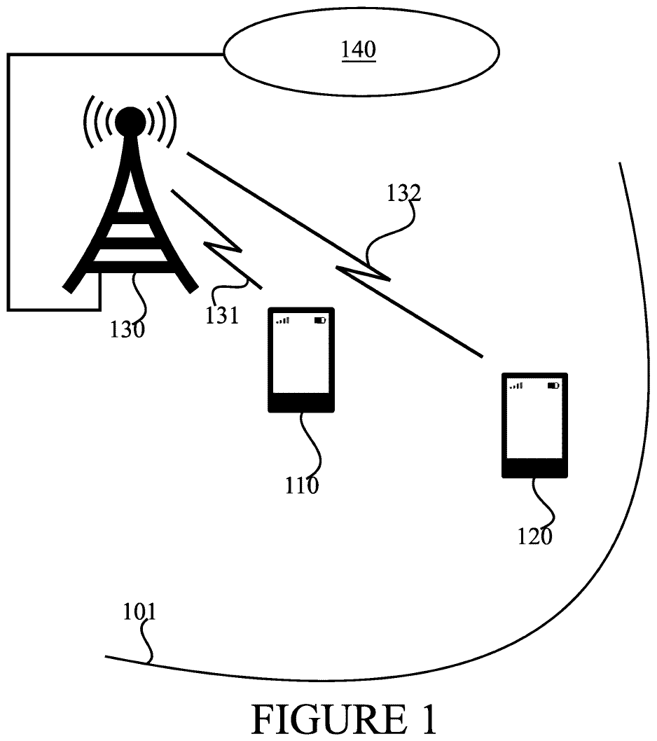

FIG. 1 illustrates an example system in accordance with at least some embodiments of the present invention. The system is a cellular communication system such as, for example, a fifth generation, 5G, also known as new radio, NR, or long term evolution, LTE, system as specified by the 3rd Generation Partnership Project, 3GPP. Some implementations of the present disclosure may also be accomplished in non-cellular systems, such as wireless local area network, WLAN, for example. The system comprises a base station 130, which may be referred to as a gNB or eNB, for example, depending on the specific technology the system is based on. Base station 130 may be distributed in that it may comprise one or more base station device, for example, base station 130 may comprise a centralized unit, CU, and one or more distributed unit, DU. A CU provides support for higher layers, such as radio resource control, RRC, while DUs handle lower layers, such as radio link control, RLC, and medium access control, MAC. In some embodiments, base station 130 is a unitary device and not distributed in nature.

Base station 130 is coupled with core network, CN, 140. CN 140 comprises nodes, such as mobility management entities, MMEs, subscriber data repositories and gateways, which serve the communication system as a whole and enable interworking with further networks, which are not illustrated in FIG. 1 for the sake of clarity. The exact names and specific functions of core network nodes, and the way CN tasks are distributed between them, depends on the technology the system of FIG. 1 is based on in each specific implementation. CN 140 may be connected to the further networks via the gateways.

Base station 130 controls a cell, the cell edge of which is schematically illustrated in FIG. 1 as edge 101. In the cell are disposed UEs 110, 120, of which UE 110 is close to base station 130 and UE 120 is close to edge 101. UE 110 communicates with base station 130 via radio link 131, and UE 120 communicates with base station 130 via radio link 132. Radio links 131, 132 may each comprise an uplink, UL, and downlink, DL, for communicating toward base station 130 and the UEs, respectively.

In general UEs may be capable of moving in the coverage area of a cell and crossing over edge 101 to coverage areas of other cells, even though some UEs may be stationary in nature in that their location does not change. Examples of such stationary UEs are communication modules of utility meters and closed-circuit video cameras, while mobile UEs include smartphones, tablet computers, laptop computers, mobile phones, and connected car connectivity modules. As such, the same UE may be near cell edge 101 and far from the edge, depending on its movement. Even for stationary UEs the distance to the cell edge 101 may change if the network is re-configured and edge 101 moves.

A physical uplink control channel, PUCCH, in NR is an example of an uplink control channel and is used to carry uplink control information, UCI, such as scheduling requests, SRs, which could also be used for beam failure recovery, BFR, requests or link failure recovery requests, hybrid automatic repeat request acknowledgements, HARQ-ACKs, and channel state information, CSI. NR PUCCH formats 2, 3 and 4 could carry HARQ-ACK, SR, and/or CSI, whereas formats 0 and 1 can only carry SR and/or up to two HARQ-ACK bits. In general, the uplink control channel may have short format(s) and long format(s). Each format has a format configuration in the PUCCH configuration. NR PUCCH formats 0 and 2 are short PUCCH formats that may occupy at most two OFDM symbols, whereas PUCCH formats 1, 3 and 4 are long PUCCH formats that occupy 4-14 OFDM symbols. In general, an uplink control channel may have two kinds of formats, short formats and long formats. Long formats can provide much better coverage as the received energy can be collected for a longer time. Typically, short formats are more suitable to be used when cyclic prefix OFDM, CP-OFDM, waveform is used with physical uplink shared channel, PUSCH, and long formats are more suitable when better coverage is required and discrete Fourier transform-spread OFDM, DFT-s-OFDM, waveform is used with PUSCH. DFT-s-OFDM has a lower PAPR than CP-OFDM and is thus, in general, more suited to coverage-limited situations, such as UE 110, 120 near the cell edge 101.

The PUCCH configuration for NR is defined in 3GPP technical standard, TS, 38.331 and contains the different parameters related to PUCCH. In this configuration, the UE could be configured with a number of PUCCH resources. PUCCH resource determination may depend on at least one of: PUCCH resource indicator, PRI, in downlink control information, DCI, UCI payload size, and other parameters used by the system.

CSI reporting may, depending on the system, support different types, including periodic, semi-persistent and aperiodic CSI reporting. A single PUCCH resource, or a list of PUCCH resources, may be configured for HARQ-ACK reporting corresponding to semi-persistent scheduling, SPS, physical downlink shared channel, PDSCH, reception(s). When two PUCCHs carrying UCI of different types overlap in time, the UE may be configured to multiplex these UCIs into PUCCH. This concerns PUCCH carrying HARQ-ACK, CSI and SR. In NR, a CSI report may comprise, for example, a channel quality indicator, a precoding matrix indicator, a CSI reference signal resource indicator, a layer indicator and a rank indicator. A received signal power indicator may also be included in a CSI report.

Switching dynamically between waveforms, such as between CP-OFDM and DFT-s-OFDM, would be beneficial since the DFT-s-OFDM waveform is beneficial for UL coverage limited and power-limited scenarios because of its lower PAPR compared to the CP-OFDM waveform. In general, DFT-s-OFDM is preferable to CP-OFDM for UEs experiencing coverage limitations. The UL waveform may be configured to the UE via RRC signaling, which incurs a high signaling load to accomplish the change of waveform. It would thus be beneficial to switch between waveforms using a more optimized, such as implicit, signaling solution.

When dynamically switching from a first waveform to a second waveform, e.g. for periodic CSI reporting on PUCCH, the UE may be configured via RRC with a CSI reporting configuration with a single PUCCH resource for a given bandwidth. This PUCCH resource could be with PUCCH format 2, 3 or 4. However, if this PUCCH resource is with format 2, which is used with CP-OFDM, and the UE is switched from CP-OFDM to DFT-s-OFDM, this resource is not suitable to be used because format 2 will have limited coverage as it is a short format and could span several radio bearers in frequency. A similar problem may be observed for HARQ-ACK reporting for SPS (PDSCH) reception, as the UE may be configured with a single PUCCH resource with format 0. However, if the PUCCH waveform is switched from CP-OFDM to DFT-s-OFDM, this resource may not be suitable as format 0 is short and a long format may be better suited to the communication situation. A related problem occurs in PUCCH determination for UCI multiplexing. Specifically, the UE may determine a PUCCH resource to carry multiplexed UCIs from a group of PUCCH resources, and some of these PUCCH resources may be suitable for CP-OFDM and the rest suitable for DFT-s-OFDM. Hence, considering dynamic waveform switching, the UE may select a PUCCH resource that isn't suitable for the waveform in use.

To enable dynamic PUCCH adaptation to the applicable waveform or selecting the correct waveform, the UE may, in addition to a first at least one PUCCH resource or at least one UCI configuration, be configured or indicated with at least one second PUCCH resource or at least one second UCI configuration for uplink control information, UCI, transmission. This at least one second PUCCH resource or at least one second UCI configuration may be considered valid or not by the UE for a PUCCH transmission depending on the applicable waveform considering dynamic waveform switching. In other words, the UE may be configured to select the first or second resource or configuration based on considerations such as which waveform is to be used. The resource or configuration corresponding to the used waveform is selected for use, and the resource or configuration corresponding to a waveform not in use is not used, and/or considered as not valid.

For UCI multiplexing or reporting on PUCCH, where the multiplexed UCIs are of the same type, such as SPS or HARQ-ACK, or of different types, the UE may transmit or multiplex two or more UCIs in the same PUCCH. For selecting a PUCCH resource to carry these UCIs, the UE may be configured to not use a PUCCH resource which does not correspond to a current applicable waveform. Then, in case of dynamic switching from a first waveform to a second waveform, when the UE switches to the second waveform (for example based on a base station indication), the UE may skip the PUCCH resource(s) which do not correspond to the second waveform, and may only consider the PUCCH resource corresponding to the second waveform as valid.

For CSI reporting configuration, within a PUCCH CSI resource list, for a bandwidth part, a second PUCCH resource may be configured in addition to a first PUCCH resource. Each of the first and second PUCCH resources corresponds to a distinct waveform. Alternatively to first and second resources, first and second resource lists may be defined corresponding to the distinct first and second waveforms. Then, in case of a switch from a first waveform to a second waveform, the UE may use the PUCCH resource or PUCCH resource list corresponding to the second waveform instead of the PUCCH resource or resource list corresponding to the first waveform. Alternatively or additionally, two or more CSI reporting configurations may be configured (e.g., with a report configuration type ‘periodic’), each one corresponding to a distinct waveform, and the UE may treat as active or applicable only the CSI reporting configuration(s) corresponding to the waveform in use.

For HARQ-ACK reporting for SPS PDSCH reception(s), a second PUCCH resource list for HARQ-ACK may be configured, in addition to a first PUCCH resource list for the HARQ-ACK. The first PUCCH resource list may correspond to a first waveform, and the second PUCCH resource list may correspond to a second waveform. A list of PUCCH resources here may contain at least one PUCCH HARQ-ACK resource for DL SPS. Such a list may be n1PUCCH-AN or sps-PUCCH-AN-List, for example in NR. In case of dynamic switching from the first waveform to the second waveform, the UE may use the PUCCH resource list corresponding to the second waveform and not the PUCCH resource list corresponding to the first waveform.

Likewise for SR configuration, a first and second PUCCH resources or configurations may be configured, corresponding respectively to the first and second waveforms, and the UE may use the first or second PUCCH resource or configuration, in dependence of which waveform is in use, such that the PUCCH resource or configuration corresponding to a waveform not in use is not used.

The correspondence used above between a PUCCH resource, resource list or a configuration and a waveform may be explicitly configured or indicated to the UE, for example via RRC signalling. Alternatively to signalling, the correspondence may be indicated in respective industry standards. For example, a PUCCH resource with format 2 or format 0 may be considered as corresponding to with CP-OFDM, and a PUCCH resource with format 3/4 or format 1 may be considered as corresponding to DTF-s-OFDM. More generally, a resource with a longer format may be considered as corresponding to a waveform with lower PAPR, and a resource with a shorter format may be considered as corresponding to a waveform with higher PAPR.

The used waveform for PUCCH may follow dynamic signalling of the waveform signalled to the UE, for example using DCI or it may be selected by the UE, for example based on a path loss parameter. Dynamic signalling may be based on physical layer DCI or MAC signalling and may be the same or different to the waveform signalling for PUSCH. This may include implicit and/or explicit signalling methods for dynamic switching of PUCCH waveform.

As one alternative, a rule can be defined as follows: if waveform switching for PUSCH indicates use of DFT-s-OFDM for PUSCH, the UE may then consider DFT-s-OFDM as the applicable waveform also for all PUCCH transmissions. Selection of the DFT-s-OFDM waveform may be accompanied with, or replaced with, selection of long a PUCCH format. Otherwise, the UE may consider CP-OFDM as the applicable waveform for PUCCH. Selection of the CP-OFDM waveform may be accompanied with, or replaced with, selection of short a PUCCH format As a variant of this, the UE may use PUCCH resources/formats corresponding to DFT-s-OFDM for all PUCCH transmissions when DFT-s-OFDM is used on PUSCH and the base station indicates also through DL DCI a PUCCH resource with a long format. In NR, long formats are formats 1, 3 and 4. Likewise in the other direction, when CP-OFDM is indicated for PUSCH (optionally together with use of a short PUCCH format), the UE may choose PUCCH resources/formats corresponding CP-OFDM resource(s) for all PUCCH transmissions.

As another alternative, if a PUCCH resource indicator in DCI indicates a PUCCH resource with a long PUCCH format (such as format 1, 3 or 4 in NR), the UE may consider DFT-s-OFDM and/or long format as applicable for all PUCCH (and/or PUSCH) transmissions, either immediately or after a certain applicability time period. Otherwise, if the PUCCH resource indicator in DCI indicates a PUCCH resource with a short PUCCH format (such as format 0 or 2 in NR), the UE considers CP-OFDM and/or short format as applicable for all PUCCH (and/or PUSCH) transmissions.

As a third alternative, reserved bits in MAC control element, CE, may be used for dynamic waveform switching for PUCCH and/or PUSCH. For example, The reserved bit R in the secondary cell activation/deactivation MAC CEs in NR may be used for indicating a waveform to the UE. As another example, one or more of the reserved bits in semi-persistent, SP, CSI reporting on PUCCH activation/deactivation MAC CE may be used for indication a waveform to be used by the UE.

As a fourth alternative, existing field(s) in DCI may be used for dynamic waveform switching for PUCCH and/or PUSCH. For example, specific time domain resource assignments, TDRAs, entry may be associated with specific waveforms via RRC signaling. Then, when indicated this entry in DCI, the UE may know which waveform to apply. As another example, a specific modulation coding scheme, MCS, entry may be associated with a specific waveform via RRC. Then, when indicated this entry in DCI, the UE may know which waveform to apply. As another example, the field ‘demodulation reference signal, DM-RS, sequence initialization’ in DCI may be interpreted and used for dynamic waveform switching indication, according to a pre-configured rule.

In general, if the dynamic waveform switching is separate for PUCCH and PUSCH and the UE determines or is indicated to use DFT-s-OFDM and/or long format for PUCCH, the UE may consider DFT-s-OFDM as also applicable for PUSCH regardless whether the latest indicated/applicable waveform for PUSCH is CP-OFDM. Likewise, if the dynamic waveform switching is separate for PUCCH and PUSCH and the UE determines or is indicated to use CP-OFDM for PUSCH, the UE may consider CP-OFDM and/or short format as also applicable for PUCCH regardless whether the latest indicated/applicable waveform for PUCCH is CP-OFDM.

While discussed above in general as selecting a waveform, in some embodiments the selection of the waveform may be accompanied by, or replaced with, selection of a long or short PUCCH format. In detail, selection of a lower-PAPR waveform (such as DFT-S-OFDM) may be accompanied with, or replaced with, selection of a long PUCCH format, since the long format also provides a benefit in terms of coverage. Likewise, selection of a higher-PAPR waveform (such as CP-OFDM) may be accompanied with, or replaced with, selection of a short PUCCH format.

In general resources for use on an uplink channel, such as PUCCH, may be defined in terms of suitability for the communication system in use. Some resources may be suitable for the first waveform and other resources may be suitable for the second waveform. For example, the resources may be defined in terms of a set of parameters. For example, the set of parameters may comprise at least one of: a starting physical resource block, PRB, or PRB offset, an intra-slot frequency hopping parameter, a second hop PRB, a first symbol index, a number of symbols, an initial cyclic shift index, interlace parameter, a number of PRBs, a time domain orthogonal cover code, OCC, OCC length, OCC index, PUCCH repetition factor, an inter-slot frequency hopping parameter, an additional demodulation reference signal, DMRS, a maximum code rate, maximum payload size, a number of slots, pi/2 binary phase-shift keying parameter, spatial relation info (and its related parameters), RB set parameter and a simultaneous hybrid repeat request acknowledge-channel state information parameter.

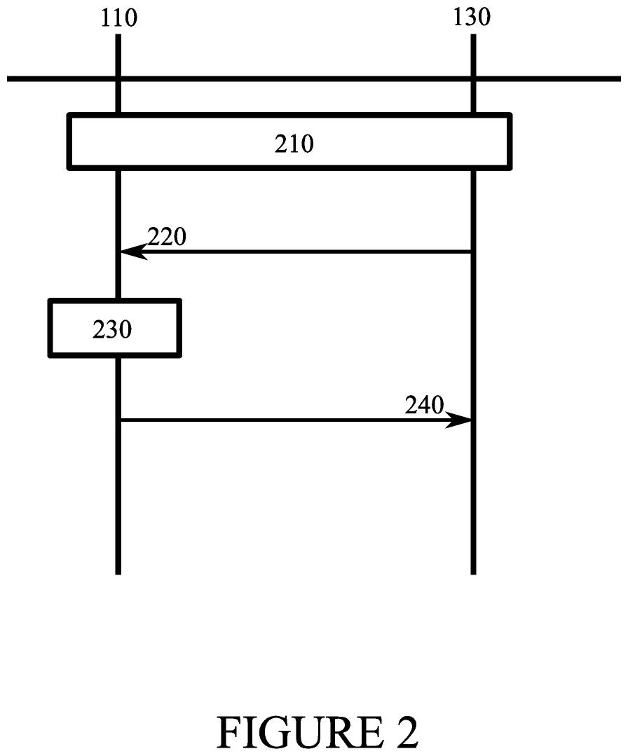

FIG. 2 illustrates an example process in accordance with at least some embodiments of the present invention. On the vertical axes are disposed UE 110 and base station 130 of FIG. 1. Time advances from the top toward the bottom.

In phase 210, base station 130 and UE 110 agree, for example directed by the base station, on first uplink resources to be used with a first waveform and second uplink resources to be used with a second waveform, different from the first waveform. The waveforms have different PAPR, the second waveform having lower PAPR. For example, the first and second uplink resources may be for UCI multiplexing.

In phase 220, base station 130 directs UE 110 to dynamically switch from using the first waveform to using the second waveform, for example to communicate at least one information element. Responsively, in phase 230, UE 110 considers as invalid, or skips without using, uplink resources that were defined in phase 210 as to be used with the first waveform, and selects uplink resources to be used with the second waveform as active resources to be used, even for second information elements other than the first information element. For example, the UE may determine that UCI multiplexing is needed, e.g. multiplexing of SPS HARQ-ACK and CSI, and the uplink resources may be selected for PUCCH used in this multiplexing to transmit the SPS HARQ-ACK and CSI.

In phase 240 UE 110 transmits uplink control channel information, such as the PUCCH with SPS HARQ-ACK and CSI, for example, using the uplink resources that were defined in phase 210 as corresponding to the second waveform.

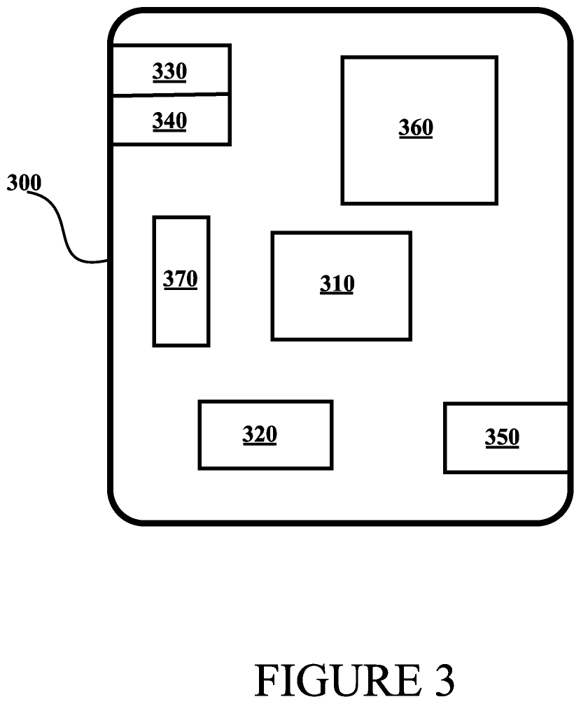

FIG. 3 illustrates an example apparatus capable of supporting at least some embodiments of the present invention. Illustrated is device 300, which may comprise, for example, a UE 110 or, in applicable parts, a base station 130 of FIG. 1. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured or designed by ARM Holdings or a Zen processing core designed by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300, such as storing, selecting and using. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as user equipment, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, New Radio, NR, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

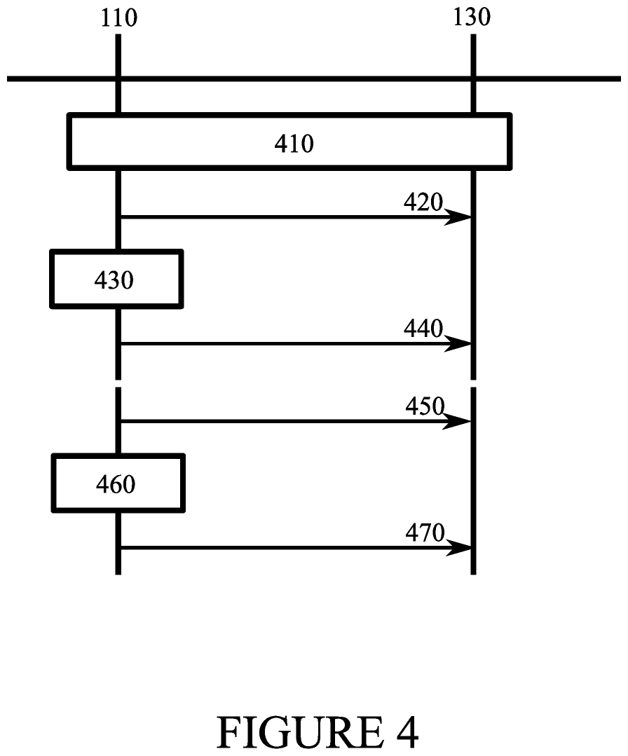

FIG. 4 illustrates signalling in accordance with at least some embodiments of the present invention. On the vertical axes are disposed, on the left, UE 110 of FIG. 1, and on the right, base station 130 of FIG. 1. Time advances from the top toward the bottom.

In phase 410, base station 130 and UE 110 agree, for example directed by the base station, on first uplink resources to be used with a first waveform and second uplink resources to be used with a second waveform, different from the first waveform. The waveforms have different PAPR, the second waveform having lower PAPR. For example, the first and second uplink resources may be for UCI multiplexing or for all PUCCH use.

Phase 420 corresponds to transmission of data from UE 110 using an uplink shared channel, such as a PUSCH in NR. Phase 430 comprises the UE, needing to transmit on an uplink control channel, selecting the first or second uplink resources for use in the uplink control channel based on which waveform is used on the uplink shared channel. In detail, if the first waveform is used on the uplink shared channel, the first uplink resources are selected by the UE and the first waveform used on the uplink control channel, and if the second waveform is used on the uplink shared channel, the second resources are selected by the UE and the second waveform used on the uplink control channel. In phase 440, the selected uplink resources and selected waveform are used by UE 110 in transmitting on the uplink control channel. The base station will have chosen, if the UE is in a coverage constrained situation, use of the lower PAPR waveform for the uplink shared channel, wherefore the UE may re-use this choice of the base station to obtain an implicit solution to selecting the correct resources (or configuration) and waveform to use.

In FIG. 4, a separate solution based on phase 410, followed by phases 450-470, is also illustrated. In this solution UE 110 wants to transmit CSI and/or SR on the uplink control channel, and UE 110 does not necessarily transmit on an uplink shared channel.

In phase 450, UE 110 transmits HARQ-ACK on the uplink control channel, or on a different uplink control channel. In phase 460, the UE selects resources for use in transmitting the CSI and/or SR on the uplink control channel, based on how the HARQ-ACK is transmitted. How the HARQ-ACK is transmitted from the UE is governed by base station 130, which knows whether UE 110 is in a coverage constrained situation. UE 110 selects the second, lower-PAPR, waveform and/or a long format for the uplink control channel (CSI and/or SR) as a response to the HARQ-ACK being signalled to be transmitted using the second waveform and/or a long control channel format.

In phase 470, UE 110 transmits the CSI and/or SR on the uplink control channel, such as PUCCH, using the waveform and/or format selected based on the HARQ-ACK transmission parameters in phase 460.

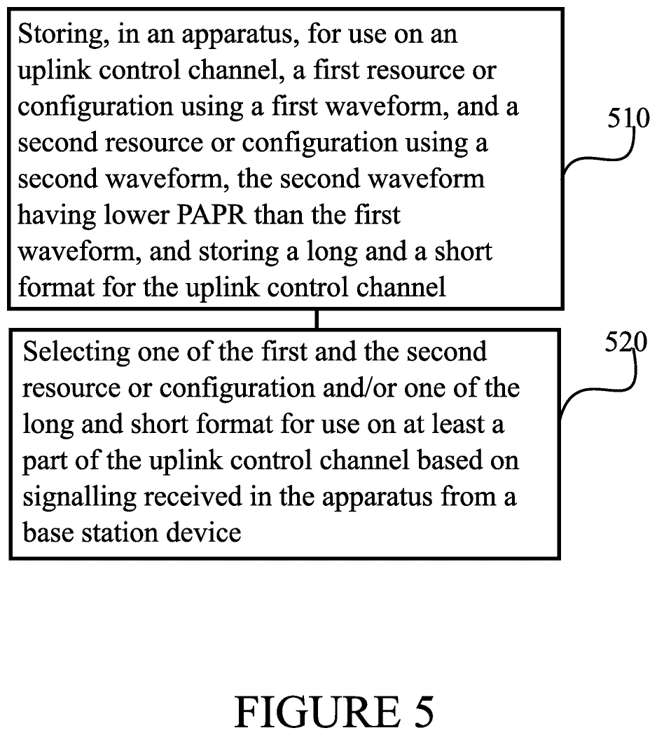

FIG. 5 is a flow graph of a method in accordance with at least some embodiments of the present invention. The phases of the illustrated method may be performed in UE 110, for example, or in a control device configured to control the functioning thereof, when installed therein.

Phase 510 comprises storing, in an apparatus, for use on an uplink control channel, a first resource or configuration using a first waveform, and a second resource or configuration using a second waveform, the second waveform having a lower peak-to-average power ratio than the first waveform, and storing a long and a short format for the uplink control channel. Phase 520 comprises selecting one of the first and the second resource or configuration and/or one of the long and short format for use on at least a part of the uplink control channel based on signalling received in the apparatus from a base station device.

The selecting comprises either 1) selecting the second resource (or configuration) and/or the long format for the uplink control channel as a response to the signalling indicating use of the second waveform for an uplink shared channel, or 2) selecting the second resource (or configuration) and/or the long format for the uplink control channel for sending a channel state information, a semi-persistent scheduling hybrid automatic repeat request acknowledgement or scheduling request as a response to the signalling indicating use of the second waveform or the long format for at least one information element other than the respective channel state information, semi-persistent scheduling hybrid automatic repeat request acknowledgement or scheduling request. For example, the selecting may comprise use of the second resource (or configuration) and/or the long format for a first one from among the channel state information, the semi-persistent scheduling hybrid automatic repeat request acknowledgement and the scheduling request as a response to the signalling indicating use of the second waveform or the long format for a second one from among the channel state information, the semi-persistent scheduling hybrid automatic repeat request acknowledgement and the scheduling request. Thus the selecting may comprise using the second resource and/or the long configuration for the first one despite not receiving an explicit instruction to use the second resource (or configuration) and/or the long configuration for the first one. In particular, the information element may comprise a physical uplink control channel, PUCCH, resource indicator carried in downlink control information, DCI, corresponding to hybrid automatic repeat request acknowledgement, HARQ-ACK with a corresponding physical downlink control channel, PDCCH.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in wireless communication.

### ACRONYMS LIST

ARQ automatic repeat request
CP-OFDM cyclic prefix OFDM
DFT-s-OFDM discrete Fourier transform-spread OFDM
HARQ hybrid ARQ
OFDM orthogonal frequency-division multiplexing
PAPR peak-to-average power ratio
PUCCH physical uplink control channel
PUSCH physical uplink shared channel

### REFERENCE SIGNS LIST

| | |
|---|---|
| 101 | Cell edge |
| 110, 120 | User equipment |
| 130 | Base station |
| 131, 132 | Radio link |
| 140 | Core network |
| 210-240 | Phases of the process of FIG. 2 |
| 300-370 | Structure of the device of FIG. 3 |
| 410-470 | Phases of the processes of FIG. 4 |
| 510-520 | Phases of the method of FIG. 5 |

1.-27. (canceled)

28. An apparatus comprising at least one processing core, at least one memory including computer program code, the at least one memory and the computer program code being configured to, with the at least one processing core, cause the apparatus at least to:
store, for use on an uplink control channel, a first resource or configuration using a first waveform, and a second resource or configuration using a second waveform, the second waveform having a lower peak-to-average power ratio than the first waveform, and store a long and a short format for the uplink control channel;
select one of the first and the second resource or configuration and/or one of the long and short format for use on at least a part of the uplink control channel based on signalling received in the apparatus from a base station device, wherein
the selecting comprises either:
selecting the second resource or configuration and/or the long format for the uplink control channel as a response to the signalling indicating use of the second waveform for an uplink shared channel, or
selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

29. The apparatus according to claim 28, wherein the first waveform is a cyclic prefix orthogonal frequency-division multiplexing, CP-OFDM, and the second waveform is a discrete Fourier transform-spread orthogonal frequency-division multiplexing waveform, DFT-s-OFDM.

30. The apparatus according to claim 28, wherein the apparatus is configured to use the selected resource or configuration, and/or the selected format, in an uplink transmission toward the base station device.

31. The apparatus according to claim 28, wherein the apparatus comprises a user equipment.

32. The apparatus according to claim 28, wherein the selecting comprises selecting the first resource or configuration and/or the short format for the uplink control channel as a response to the signalling indicating use of the first waveform for an uplink shared channel.

33. The apparatus according to claim 28, wherein the selecting comprises selecting the first resource or configuration and/or the short format for the uplink control channel for sending the channel state information, the semi-persistent scheduling hybrid automatic repeat request acknowledgement or the scheduling request as a response to the signalling indicating use of the information element other than the respective channel state information, semi-persistent scheduling hybrid automatic repeat request acknowledgement or scheduling request.

34. The apparatus according to claim 28, wherein the signalling comprises a physical uplink control channel resource indicator carried in downlink control information.

35. The apparatus according to claim 28, wherein the short format comprises a format with one or two orthogonal frequency-division multiplexing, OFDM, symbols and the long format comprises 4-14 OFDM symbols.

36. The apparatus according to claim 28, wherein each of the first and second resources comprises a set of communication parameters.

37. The apparatus according to claim 36, wherein the set of communication parameters comprises at least one of: a starting physical resource block, PRB, or PRB offset, an intra-slot frequency hopping parameter, a second hop PRB, a first symbol index, a number of symbols, an initial cyclic shift index, interlace parameter, a number of PRBs, a time domain orthogonal cover code, OCC, OCC length, OCC index, PUCCH repetition factor, an inter-slot frequency hopping parameter, an additional demodulation reference signal, DMRS, a maximum code rate, maximum payload size, a number of slots, pi/2 binary phase-shift keying parameter, spatial relation information and a simultaneous hybrid repeat request acknowledge-channel state information parameter.

38. The apparatus according to claim 28, wherein each of the first and second configurations comprises at least one resource, each resource comprising one or more parameters.

39. An apparatus comprising at least one processing core, at least one memory including computer program code, the at least one memory and the computer program code being configured to, with the at least one processing core, cause the apparatus at least to:
provide, to a user equipment, for use on an uplink control channel, a first resource or configuration which uses a first waveform, and a second resource or configuration which uses a second waveform, the second waveform having a lower peak-to-average power ratio than the first waveform, and
provide signalling to the user equipment, the signalling defining use of the first or the second waveform for use in a physical uplink shared channel or in communication of an information element from the user equipment.

40. An apparatus comprising means for:
storing, in an apparatus, for use on an uplink control channel, a first resource or configuration using a first waveform, and a second resource or configuration using a second waveform, the second waveform having a lower peak-to-average power ratio than the first waveform, and storing a long and a short format for the uplink control channel;
selecting one of the first and the second resource or configuration and/or one of the long and short format for use on at least a part of the uplink control channel based on signalling received in the apparatus from a base station device, wherein
the selecting comprises either:
selecting the second resource or configuration and/or the long format for the uplink control channel as a response to the signalling indicating use of the second waveform for an uplink shared channel, or
selecting the second resource or configuration and/or the long format for the uplink control channel for sending a channel state information, a semi-persistent scheduling hybrid automatic repeat request acknowledgement or a scheduling request as a response to the signalling indicating use of the second waveform or the long format for at least one information element other than the respective channel state information, semi-persistent scheduling hybrid automatic repeat request acknowledgement or scheduling request.

41. The apparatus according to claim 40, wherein the apparatus further comprises means for:
selecting the first resource or configuration and/or the short format for the uplink control channel as a response to the signalling indicating use of the first waveform for an uplink shared channel.

42. The apparatus according to claim 40, wherein the means for selecting further comprises means for:
selecting the first resource or configuration and/or the short format for the uplink control channel for sending the channel state information, the semi-persistent scheduling hybrid automatic repeat request acknowledgement or the scheduling request as a response to the signalling indicating use of the information element other than the respective channel state information, semi-persistent scheduling hybrid automatic repeat request acknowledgement or scheduling request.

43. The apparatus according to claim 40, wherein the signalling comprises a physical uplink control channel resource indicator carried in downlink control information.

44. The apparatus according to claim 40, wherein the short format comprises a format with one or two orthogonal frequency-division multiplexing, OFDM, symbols and the long format comprises 4-14 OFDM symbols.

45. The apparatus according to claim 40, wherein each of the first and second resources comprises a set of communication parameters.

46. The apparatus according to claim 45, wherein the set of communication parameters comprises at least one of: a starting physical resource block, PRB, or PRB offset, an intra-slot frequency hopping parameter, a second hop PRB, a first symbol index, a number of symbols, an initial cyclic shift index, interlace parameter, a number of PRBs, a time domain orthogonal cover code, OCC, OCC length, OCC index, PUCCH repetition factor, an inter-slot frequency hopping parameter, an additional demodulation reference signal, DMRS, a maximum code rate, maximum payload size, a number of slots, pi/2 binary phase-shift keying parameter, spatial relation information and a simultaneous hybrid repeat request acknowledge-channel state information parameter.

47. The apparatus according to claim 40, wherein each of the first and second configurations comprises at least one resource, each resource comprising one or more parameters.
